(19) United States
(12) Patent Application Publication
(10) Pub. No.: US 2023/0039989 A1
(43) Pub. Date: Feb. 9, 2023

(54) VEHICLE CONTROL DEVICE

(71) Applicant: Toyota Jidosha Kabushiki Kaisha, Toyota-shi (JP)

(72) Inventor: Yusuke TANAKA, Anjo-shi (JP)

(73) Assignee: Toyota Jidosha Kabushiki Kaisha, Toyota-shi (JP)

(21) Appl. No.: 17/870,263

(22) Filed: Jul. 21, 2022

(30) Foreign Application Priority Data
Aug. 4, 2021 (JP) 2021-128342

(51) Int. Cl. B60W 50/12; B60W 40/08; B60W 30/09; B60W 30/14; B60W 30/16; B60W 30/12; B60W 10/20; B60Q 5/00

(52) U.S. Cl. CPC B60W 50/12; B60Q 5/00; B60W 10/20; B60W 30/09; B60W 30/12; B60W 30/16; B60W 30/146; B60W 40/08; B60W 2040/0818; B60W 2540/26

(57) ABSTRACT

A vehicle control device executes driving assistance control for assisting driving a host vehicle by a driver. The vehicle control device stops the driving assistance control under execution when a predetermined actuator of the host vehicle is operated. The vehicle control device executes, as the driving assistance control, abnormality countermeasure control for securing safe traveling of the host vehicle when the driver falls into an abnormal state having a problem in driving the host vehicle, and when the predetermined actuator is operated, and when the abnormality countermeasure control is not being executed, stops the driving assistance control, and when the abnormality countermeasure control is being executed, does not stop the driving assistance control including the abnormality countermeasure control.

### CROSS-REFERENCE TO RELATED APPLICATION

This application claims priority to Japanese Patent Application No. 2021-128342 filed on Aug. 4, 2021, incorporated herein by reference in its entirety.

### BACKGROUND

### 1. Technical Field

The present disclosure relates to a vehicle control device.

### 2. Description of Related Art

A vehicle control device that executes abnormality countermeasure traveling control (dead-man control) for starting follow-up traveling to make a host vehicle travel to follow up a preceding vehicle when a driver falls into an abnormal state (a state in which the driver has a problem in driving the host vehicle due to unconsciousness or the like) in driving the host vehicle and ending the follow-up traveling when the host vehicle is stopped following the stop of the preceding vehicle with the follow-up traveling is known (for example, see Japanese Patent No. 5919150 (JP 5919150 B). With this, even though the driver falls into the abnormal state, the host vehicle is safely stopped.

### SUMMARY

It is preferable that, when confirmation is made that the driver is in a normal state after the start of the abnormality countermeasure traveling control, the abnormality countermeasure traveling control is stopped at the point of time. Then, for example, a case where, when an operation on an actuator, such as a switch, for operating a vehicle stop holding device, such as an electric parking brake, is detected after the start of the abnormality countermeasure traveling control, determination is made that the driver is in the normal state, and the abnormality countermeasure traveling control is stopped is considered.

However, an occupant (for example, an occupant on an assistant driver’s seat) other than the driver can readily operate the actuator for operating the vehicle stop holding device. For this reason, even though the actuator for operating the vehicle stop holding device is operated, the driver is likely to be in the abnormal state yet. Accordingly, in a case where, when an operation on the actuator for operating the vehicle stop holding device is detected, determination is made that the driver is in the normal state, and the abnormality countermeasure traveling control is stopped, the host vehicle cannot be safely stopped.

The disclosure provides a vehicle control device capable of restraining abnormality countermeasure control from being stopped in a situation in which the stop of the abnormality countermeasure control is not appropriate.

An aspect of the disclosure relates to a vehicle control device that executes driving assistance control for assisting driving of a host vehicle by a driver. The vehicle control device is configured to stop the driving assistance control under execution when a predetermined actuator of the host vehicle is operated. The vehicle control device is configured to execute, as the driving assistance control, abnormality countermeasure control for securing safe traveling of the host vehicle when the driver falls into an abnormal state having a problem in driving the host vehicle, and when the predetermined actuator is operated, and when the abnormality countermeasure control is not being executed, stop driving assistance control, and when the abnormality countermeasure control is being executed, not stop the driving assistance control including the abnormality countermeasure control.

With the vehicle control device according to the aspect of the disclosure, even though an occupant other than the driver operates the actuator when the driver falls into the abnormal state, the driving assistance control including the abnormality countermeasure control is not stopped. Accordingly, it is possible to restrain the abnormality countermeasure control from being stopped in a situation in which the stop of the abnormality countermeasure control is not appropriate.

In the vehicle control device according to the aspect of the disclosure, the predetermined actuator may be, for example, an actuator for operating a vehicle stop holding device that holds the host vehicle in a stop state.

Examples of an actuator that is highly likely operated by the occupant other than the driver when the driver falls into the abnormal state include the actuator for operating the vehicle stop holding device. With the vehicle control device according to the aspect of the disclosure, even though the actuator that is highly likely to be operated when the driver falls into the abnormal state is operated, it is possible to restrain the abnormality countermeasure control from being stopped.

In the vehicle control device according to the aspect of the disclosure, the abnormality countermeasure control may include, for example, abnormality countermeasure traveling control for decelerating and stopping the host vehicle.

With the vehicle control device according to the aspect of the disclosure, even though the actuator is being operated when the abnormality countermeasure traveling control is executed as the abnormality countermeasure control, it is possible to restrain the abnormality countermeasure traveling control from being stopped.

In the vehicle control device according to the aspect of the disclosure, the abnormality countermeasure control may include, for example, abnormality alarm control for informing an outside of the host vehicle that the driver falls into the abnormal state.

With the vehicle control device according to the aspect of the disclosure, even though the actuator is operated when the abnormality alarm control is being executed as the abnormality countermeasure control, it is possible to restrain the abnormality alarm control from being stopped.

In the vehicle control device according to the aspect of the disclosure, the driving assistance control may include, for example, follow-up traveling control for automatically performing acceleration and deceleration of the host vehicle such that the host vehicle travels to follow up a preceding vehicle.

With the vehicle control device according to the aspect of the disclosure, even though the actuator is operated when the follow-up traveling control is being executed matching the abnormality countermeasure control, it is possible to restrain the follow-up traveling control from being stopped.

In the vehicle control device according to the aspect of the disclosure, the driving assistance control may include, for example, lane keeping control for assisting a steering operation by the driver on the host vehicle such that the host vehicle travels within a lane.

With the vehicle control device according to the aspect of the disclosure, even though the actuator is operated when the lane keeping control is being executed matching the abnormality countermeasure control, it is possible to restrain the lane keeping control from being stopped.

The components of the disclosure are not limited to an embodiment of the disclosure described below referring to the drawings. Other objects, other features, and attendant advantages of the disclosure will be readily appreciated from the following description of the embodiment of the disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a vehicle control device according to an embodiment of the disclosure and a vehicle (host vehicle) in which the vehicle control device is mounted;

FIG. 2A is a diagram showing a scene where the host vehicle is traveling at a center of a lane with steering assistance through lane keeping control;

FIG. 2B is a diagram showing a scene where the host vehicle is near a right side from the center of the lane during execution of the lane keeping control;

FIG. 2C is a diagram showing a scene where the host vehicle is near a left side from the center of the lane during execution of the lane keeping control;

FIG. 3A is a diagram showing a distance (inter-vehicle distance) between the host vehicle and a preceding vehicle;

FIG. 3B is a diagram showing a scene where the inter-vehicle distance is longer than a target inter-vehicle distance in follow-up traveling control;

FIG. 3C is a diagram showing a scene where the inter-vehicle distance is shorter than the target inter-vehicle distance in the follow-up traveling control;

FIG. 4 is a diagram showing the host vehicle that is traveling through abnormality countermeasure control when a driver of the host vehicle falls into the abnormal state;

FIG. 5 is a flowchart showing a routine that is executed by the vehicle control device according to the embodiment of the disclosure;

FIG. 6 is a flowchart showing a routine that is executed by the vehicle control device according to the embodiment of the disclosure;

FIG. 7 is a flowchart showing a routine that is executed by the vehicle control device according to the embodiment of the disclosure;

FIG. 8 is a flowchart showing a routine that is executed by the vehicle control device according to the embodiment of the disclosure;

FIG. 9 is a flowchart showing a routine that is executed by the vehicle control device according to the embodiment of the disclosure;

FIG. 10 is a flowchart showing a routine that is executed by the vehicle control device according to the embodiment of the disclosure;

FIG. 11 is a flowchart showing a routine that is executed by the vehicle control device according to the embodiment of the disclosure;

FIG. 12 is a flowchart showing a routine that is executed by the vehicle control device according to the embodiment of the disclosure;

FIG. 13 is a flowchart showing a routine that is executed by the vehicle control device according to the embodiment of the disclosure; and

FIG. 14 is a flowchart showing a routine that is executed by the vehicle control device according to the embodiment of the disclosure.

### DETAILED DESCRIPTION OF EMBODIMENTS

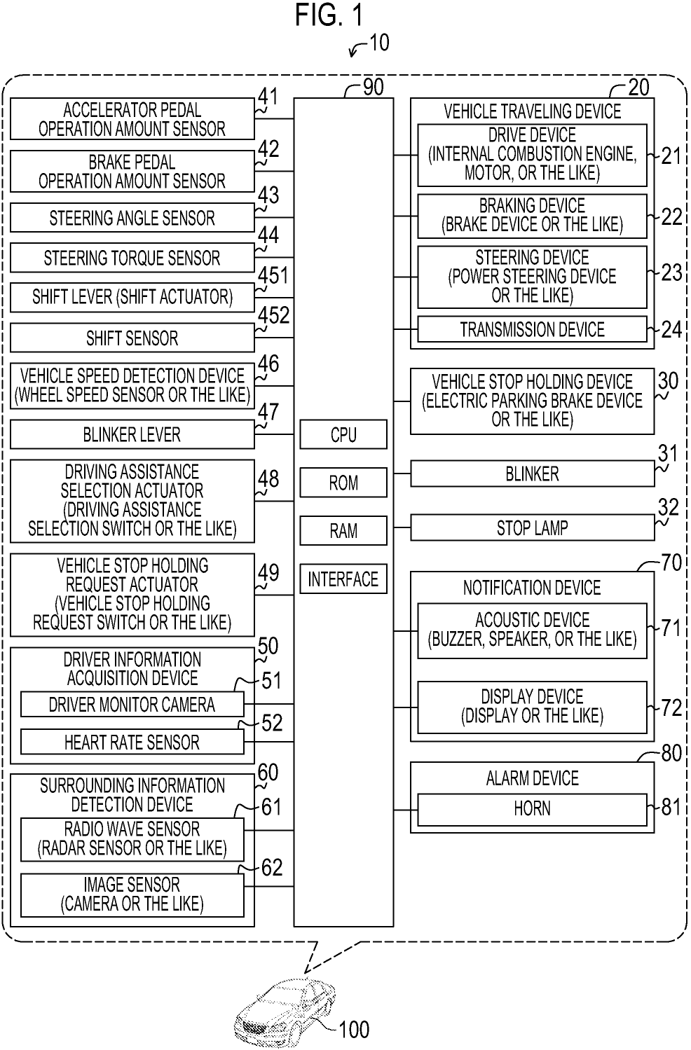

Hereinafter, a vehicle control device according to an embodiment of the disclosure will be described referring to the drawings. As shown in FIG. 1, the vehicle control device according to the embodiment of the disclosure 10 is mounted in a vehicle (host vehicle 100).

The vehicle control device 10 includes an ECU 90. The ECU 90 includes a microcomputer as a main part. The ECU 90 includes a CPU, a ROM, a RAM, a non-volatile memory, an interface, and the like. The CPU realizes various functions by executing instructions (programs, routines) stored in the ROM.

### Vehicle Traveling Device

A vehicle traveling device 20 is mounted in the host vehicle 100. The vehicle traveling device 20 is a device that performs drive, braking, steering, and shift change of the host vehicle 100, and in this example, includes a drive device 21, a braking device 22, a steering device 23, and a transmission device 24.

### Drive Device

The drive device 21 is a device that outputs drive power to be applied to the host vehicle 100 to make the host vehicle 100 travel, and is, for example, at least one of an internal combustion engine and a motor. The drive device 21 is electrically connected to the ECU 90. The ECU 90 can control the drive power output from the drive device 21 by controlling the operation of the drive device 21.

### Braking Device

The braking device 22 is a device that outputs braking force to be applied to the host vehicle 100 to brake the host vehicle 100, and is, for example, a hydraulic brake device. The braking device 22 is electrically connected to the ECU 90. The ECU 90 can control the braking force output from the braking device 22 by controlling the operation of the braking device 22.

### Steering Device

The steering device 23 is a device that outputs steering force to be applied to the host vehicle 100 to steer the host vehicle 100, and is, for example, a power steering device. The steering device 23 is electrically connected to the ECU 90. The ECU 90 can control the steering force output from the steering device 23 by controlling the operation of the steering device 23.

### Transmission Device

The transmission device 24 is a device that switches whether or not to transmit the drive power output from the drive device 21 to drive wheels of the host vehicle 100 or switches whether to transmit the drive power to the drive wheels to move the host vehicle 100 forward or whether to transmit the drive power to the drive wheels to move the host vehicle 100 backward. The transmission device 24 is a device that holds the host vehicle 100 in a stop state by hooking a claw-shaped part (parking lock pole) to a gear of the transmission device 24 to lock the gear to be not rotated. Accordingly, the transmission device 24 also functions as a vehicle stop holding device that holds the host vehicle 100 in the stop state.

The transmission device 24 operates in any state of a state in which the drive power is transmitted to the drive wheels to move the host vehicle 100 forward (a drive range state SD), a state in which the drive power is transmitted to the drive wheels to move the host vehicle 100 backward (a reverse range state SR), a state in which the drive power is not transmitted to the drive wheels of the host vehicle 100 (a neutral range state SN), and a state in which the host vehicle 100 is held in the stop state (a parking range state SP).

The transmission device 24 is electrically connected to the ECU 90. The ECU 90 can set the transmission device 24 to any state of the drive range state SD, the reverse range state SR, the neutral range state SN, and the parking range state SP by controlling the transmission device 24.

### Vehicle Stop Holding Device

A vehicle stop holding device 30 is mounted in the host vehicle 100. The vehicle stop holding device 30 is a device that holds the host vehicle 100 in the stop state, and is, for example, an electric parking brake device. The electric parking brake device is a device that can apply the braking force to the wheels of the host vehicle 100. In particular, the electric parking brake device is a device that can apply the braking force to the wheels by pressing brake pads against brake disks provided in the wheels of the host vehicle 100. The vehicle stop holding device 30 is electrically connected to the ECU 90. The ECU 90 can hold the stopped host vehicle 100 in the stop state or can decelerate the traveling host vehicle 100 by operating the vehicle stop holding device 30.

### Blinker

Blinkers 31 are mounted in the host vehicle 100. The blinkers 31 are devices that indicate a direction in which the host vehicle 100 turns, to a person outside the host vehicle 100. The blinkers 31 are provided a front right corner portion, a front left corner portion, a rear right corner portion, and a rear left corner portion of the host vehicle 100. The blinkers 31 are electrically connected to the ECU 90. The ECU 90 operates the blinkers 31 depending on an operation on a blinker lever 47 described below.

### Stop Lamp

Stop lamps 32 are mounted in the host vehicle 100. The stop lamps 32 are devices that mainly indicate the operation of a brake pedal to a person outside the host vehicle 100. The stop lamps 32 are provided adjacent to the blinkers 31 provided in the rear right corner portion and the rear left corner portion of the host vehicle 100, respectively. The stop lamps 32 are electrically connected to the ECU 90. For example, the ECU 90 turns on the stop lamps 32 when the brake pedal is operated by a driver DR.

### Sensors and the Like

An accelerator pedal operation amount sensor 41, a brake pedal operation amount sensor 42, a steering angle sensor 43, a steering torque sensor 44, a shift sensor 452, a vehicle speed detection device 46, a blinker lever 47, a driving assistance selection actuator 48, a vehicle stop holding request actuator 49, a driver information acquisition device 50, and a surrounding information detection device 60 are mounted in the host vehicle 100.

### Accelerator Pedal Operation Amount Sensor

The accelerator pedal operation amount sensor 41 is a sensor that detects an operation amount of an accelerator pedal of the host vehicle 100. The accelerator pedal operation amount sensor 41 is electrically connected to the ECU 90. The accelerator pedal operation amount sensor 41 transmits information regarding the detected operation amount of the accelerator pedal to the ECU 90. The ECU 90 acquires the operation amount of the accelerator pedal as an accelerator pedal operation amount AP based on the information.

The ECU 90 acquires requested drive power (requested drive torque) based on the accelerator pedal operation amount AP and a traveling speed (host vehicle speed) of the host vehicle 100 by calculation, except for a case of executing follow-up traveling control and abnormality countermeasure traveling control described below. The ECU 90 controls the operation of the drive device 21 such that the requested drive power is output. In a case of executing the follow-up traveling control and the abnormality countermeasure traveling control described below, the ECU 90 decides drive power needed for making the host vehicle 100 travel as desired through the follow-up traveling control and the abnormality countermeasure traveling control, and controls the operation of the drive device 21 such that the drive power is output.

### Brake Pedal Operation Amount Sensor

The brake pedal operation amount sensor 42 is a sensor that detects an operation amount of the brake pedal of the host vehicle 100. The brake pedal operation amount sensor 42 is electrically connected to the ECU 90. The brake pedal operation amount sensor 42 transmits information regarding the detected operation amount of the brake pedal to the ECU 90. The ECU 90 acquires the operation amount of the brake pedal as a brake pedal operation amount BP based on the information.

The ECU 90 acquires requested braking force (requested braking torque) from the brake pedal operation amount BP by calculation, except for a case of executing the follow-up traveling control and the abnormality countermeasure traveling control described below. The ECU 90 controls the operation of the braking device 22 such that the requested braking force is output. In a case of executing the follow-up traveling control and the abnormality countermeasure traveling control described below, the ECU 90 decides braking force needed for making the host vehicle 100 travel as desired through the follow-up traveling control and the abnormality countermeasure traveling control, and controls the operation of the braking device 22 such that the braking force is output.

### Steering Angle Sensor

The steering angle sensor 43 is a sensor that detects a rotation angle with respect to a neutral position of a steering shaft of the host vehicle 100. The steering angle sensor 43 is electrically connected to the ECU 90. The steering angle sensor 43 transmits information regarding the detected rotation angle of the steering shaft to the ECU 90. The ECU 90 acquires the rotation angle of the steering shaft as a steering angle θ based on the information.

### Steering Torque Sensor

The steering torque sensor 44 is a sensor that detects torque input to the steering shaft by the driver DR of the host vehicle 100 through a steering wheel of the host vehicle 100. The steering torque sensor 44 is electrically connected to the ECU 90. The steering torque sensor 44 transmits information regarding the detected torque to the ECU 90. The ECU 90 acquires torque (driver input steering torque TQdriver) input to the steering shaft by the driver DR through the steering wheel based on the information.

The ECU 90 acquires requested steering force (requested steering torque) based on the steering angle θ, the driver input torque, and the traveling speed (host vehicle speed) of the host vehicle 100 and controls the operation of the steering device 23 such that the requested steering torque is output from the steering device 23, except for a case of executing lane keeping control and the abnormality countermeasure traveling control described below. In a case of executing the lane keeping control and the abnormality countermeasure traveling control described below, the ECU 90 decides steering force needed for making the host vehicle 100 travel as desired through the lane keeping control and the abnormality countermeasure traveling control, and controls the operation of the steering device 23 such that the steering force is output.

### Shift Sensor

The shift sensor 452 is a sensor that detects a set position of a shift lever 451 as a shift actuator of the host vehicle 100. The shift lever 451 is a device that is operated by the driver DR of the host vehicle 100, and the set position of the shift lever 451 that can be set by the driver DR is a drive position (drive range), a reverse position (reverse range), a neutral position (neutral range), and a parking position (parking range). The shift sensor 452 is electrically connected to the ECU 90. The shift sensor 452 transmits a signal indicating the detected set position of the shift lever 451 to the ECU 90.

In a case where the shift lever 451 is set to the drive range, the shift sensor 452 transmits, to the ECU 90, a signal indicating that the set position of the shift lever 451 is the drive range. In a case where the signal is received, the ECU 90 controls the operation of the transmission device 24 such that the transmission device 24 is brought into the drive range state SD.

In a case where the shift lever 451 is set to the reverse range, the shift sensor 452 transmits, to the ECU 90, a signal indicating that the set position of the shift lever 451 is the reverse range. In a case where the signal is received, the ECU 90 controls the operation of the transmission device 24 such that the transmission device 24 is brought into the reverse range state SR.

In a case where the shift lever 451 is set to the neutral range, the shift sensor 452 transmits, to the ECU 90, a signal indicating that the set position of the shift lever 451 is the neutral range. In a case where the signal is received, the ECU 90 controls the operation of the transmission device 24 such that the transmission device 24 is brought into the neutral range state SN.

In a case where the shift lever 451 is set to the parking range, the shift sensor 452 transmits, to the ECU 90, a signal indicating that the set position of the shift lever 451 is the parking range. In a case where the signal is received, the ECU 90 controls the operation of the transmission device 24 such that the transmission device 24 is brought into the parking range state SP.

In a case of executing the follow-up traveling control and the abnormality countermeasure traveling control described below, the ECU 90 controls the operation of the transmission device 24 (performs shift change) depending on a need for making the host vehicle 100 travel as desired through the follow-up traveling control and the abnormality countermeasure traveling control.

### Vehicle Speed Detection Device

The vehicle speed detection device 46 is a device that detects the traveling speed of the host vehicle 100, and is, for example, a wheel speed sensor. The vehicle speed detection device 46 is electrically connected to the ECU 90. The vehicle speed detection device 46 transmits information regarding the detected traveling speed of the host vehicle 100 to the ECU 90. The ECU 90 acquires the traveling speed (host vehicle speed V100) of the host vehicle 100 based on the information.

### Blinker Lever

The blinker lever 47 is equipment that is operated by the driver DR to operate the blinkers 31. The blinker lever 47 is electrically connected to the ECU 90. When the blinker lever 47 is operated clockwise, the ECU 90 makes the blinkers 31 provided in the front right corner portion and the rear right corner portion blink. On the other hand, when the blinker lever 47 is operated counterclockwise, the ECU 90 makes the blinkers 31 provided in the front left corner portion and the rear left corner portion blink. The ECU 90 can also make all blinkers 31 blink at a predetermined time interval. Hereinafter, the blinking of all blinkers 31 at the predetermined time interval is called “hazard blinking”.

### Driving Assistance Selection Actuator

The driving assistance selection actuator 48 is equipment that is operated by the driver DR to execute the lane keeping control described below, to execute the follow-up traveling control described below, or to set a predetermined inter-vehicle distance Dset and a predetermined vehicle speed Vset in the follow-up traveling control, and is, for example, a driving assistance selection switch. The driving assistance selection actuator 48 is electrically connected to the ECU 90. When an operation to execute the lane keeping control is applied to the driving assistance selection actuator 48, the ECU 90 determines that the execution of the lane keeping control is requested. When an operation to execute the follow-up traveling control is applied to the driving assistance selection actuator 48, the ECU 90 determines that the execution of the follow-up traveling control is requested.

### Vehicle Stop Holding Request Actuator

The vehicle stop holding request actuator 49 is equipment that is operated by the driver DR to operate the vehicle stop holding device 30, and is, for example, a vehicle stop holding request switch. The vehicle stop holding request actuator 49 is electrically connected to the ECU 90. When an operation to operate the vehicle stop holding device 30 is applied to the vehicle stop holding request actuator 49, the ECU 90 operates the vehicle stop holding device 30 such that the host vehicle 100 is held in the stop state when the host vehicle 100 is stopped, and operates the vehicle stop holding device 30 such that the host vehicle 100 is decelerated at an appropriate deceleration and stopped when the host vehicle 100 is traveling.

### Driver Information Acquisition Device

The driver information acquisition device 50 is a device that acquires information regarding the driver DR, and in this example, includes a driver monitor camera 51 and a heart rate sensor 52.

### Driver Monitor Camera

The driver monitor camera 51 is a device that images the driver DR. The driver monitor camera 51 is electrically connected to the ECU 90. The driver monitor camera 51 transmits information regarding a captured image of the driver DR to the ECU 90. The ECU 90 acquires information (driver information ID) regarding a status of the driver DR based on the information (driver image information). The ECU 90 can determine whether or not the driver DR is in an abnormal state based on the driver information ID. In this example, the abnormal state is a state in which the driver DR has a problem in driving the host vehicle 100 due to unconsciousness or the like.

### Heart Rate Sensor

The heart rate sensor 52 is a sensor that detects a heart rate of the driver DR of the host vehicle 100. The heart rate sensor 52 is electrically connected to the ECU 90. The heart rate sensor 52 transmits information regarding the detected heart rate to the ECU 90. The ECU 90 acquires the heart rate of the driver DR based on the information (heart rate information). The ECU 90 acquires information (driver information ID) regarding the status of the driver DR based on the acquired heart rate of the driver DR. The ECU 90 can determine whether or not the driver DR is in an abnormal state based on the driver information ID.

### Surrounding Information Detection Device

The surrounding information detection device 60 is a device that detects information regarding the surrounding of the host vehicle 100, and in this example, includes a radio wave sensor 61 and an image sensor 62.

### Radio Wave Sensor

The radio wave sensor 61 is a sensor that detects information regarding an object surrounding the host vehicle 100 using radio wave, and is, for example, at least one of a sound wave sensor, such as a radar sensor (millimeter-wave radar or the like) or an ultrasonic sensor (clearance sonar), and an optical sensor, such as a laser radar (LiDAR). The radio wave sensor 61 is electrically connected to the ECU 90. The radio wave sensor 61 sends a radio wave and receives a radio wave (reflected wave) reflected by an object. The radio wave sensor 61 transmits information regarding the sent radio wave and the received radio wave (reflected wave) to the ECU 90. In other words, the radio wave sensor 61 detects an object surrounding the host vehicle 100 and transmits information regarding the detected object to the ECU 90. The ECU 90 can acquire information (surrounding detection information IS) regarding an object surrounding the host vehicle 100 based on the information (radio wave information IR or radio wave data). An object that is detected using the radio wave sensor 61 is, for example, a vehicle, a wall, a bicycle, or a person.

### Image Sensor

The image sensor 62 is a sensor that images the surrounding of the host vehicle 100, and is, for example, a camera. The image sensor 62 is electrically connected to the ECU 90. The image sensor 62 images the surrounding of the host vehicle 100 and transmits information regarding a captured image to the ECU 90. The ECU 90 can acquire information (surrounding information IS) regarding the surrounding of the host vehicle 100 based on the information (image information IC or image data).

### Notification Device

The notification device 70 is a device that performs various notifications to the driver DR, and in this example, includes an acoustic device 71 and a display device 72.

### Acoustic Device

The acoustic device 71 is a device that outputs sound in a cabin of the host vehicle 100, and is, for example, a buzzer or a speaker. The acoustic device 71 is electrically connected to the ECU 90. The ECU 90 can output various kinds of sound or voice in the cabin of the host vehicle 100 through the acoustic device 71.

### Display Device

The display device 72 is a device that displays an image, and is, for example, a display. The display device 72 is installed in the cabin of the host vehicle 100 to be viewed by the driver DR. The display device 72 is electrically connected to the ECU 90. The ECU 90 can display various images on the display device 72.

### Alarm Device

The alarm device 80 is a device that performs various alarms to a person outside the host vehicle 100, and in this example, includes a horn 81.

### Horn

The horn 81 is a device that outputs sound outside the host vehicle 100. The horn 81 is electrically connected to the ECU 90. The ECU 90 can output sound from the horn 81.

### Outline of Operation

Next, the outline of the operation of the vehicle control device 10 will be described. When a predetermined condition is established, the vehicle control device 10 executes driving assistance control depending on the predetermined condition. In this example, the driving assistance control is the lane keeping control, the follow-up traveling control, and the abnormality countermeasure control.

### Lane Keeping Control

When the execution of the lane keeping control is requested by an operation of the driving assistance selection actuator 48, the vehicle control device 10 executes the lane keeping control. The lane keeping control is control for assisting a steering operation by the driver DR on the host vehicle 100 such that the host vehicle 100 travels between right and left white lines of the host vehicle 100 (that is, within a host vehicle lane LN1). More specifically, the lane keeping control is control for controlling the operation of the steering device 23 such that the host vehicle 100 travels at the center of the host vehicle lane LN1.

Reference numeral LN2 in the drawing is a lane adjacent to the host vehicle lane LN1, and a lane on which an oncoming vehicle travels.

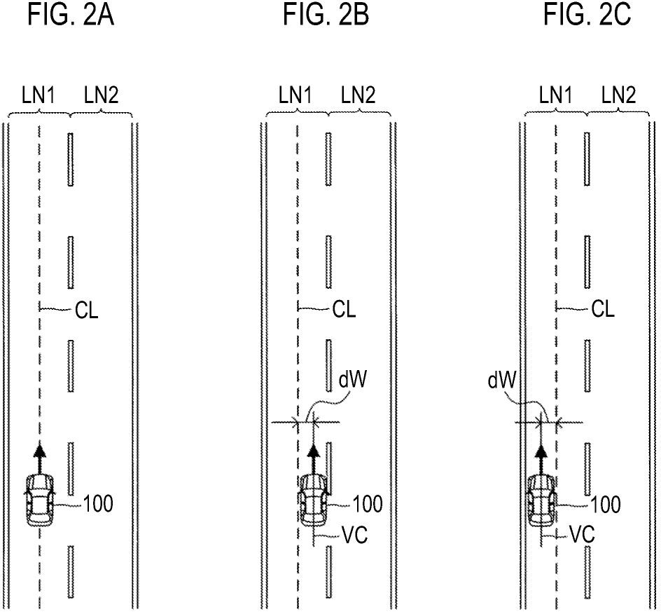

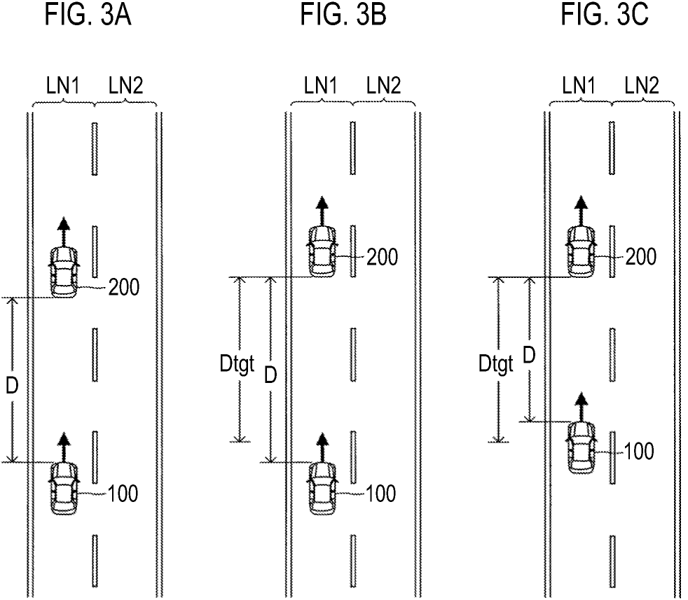

In a case where the lane keeping control starts, the vehicle control device 10 acquires a center line (lane center line CL) of the host vehicle lane LN1 (see FIG. 2A). The vehicle control device 10 acquires the lane center line CL based on the surrounding detection information IS.

The vehicle control device 10 acquires a deviation amount dW between a line (host vehicle center line VC) of the center of the host vehicle 100 and the lane center line CL (see FIGS. 2B and 2C). The host vehicle center line VC is a line that extends in a front-rear direction from the center in a width direction of the host vehicle 100.

When the deviation amount dW is greater than zero, the vehicle control device 10 steers the host vehicle 100 by controlling the operation of the steering device 23 such that the deviation amount dW is zero. As shown in FIG. 2B, in a case where the host vehicle 100 deviates from the center of the host vehicle lane LN1 to the right side and the deviation amount dW is greater than zero, the vehicle control device 10 controls the operation of the steering device 23 to turn the host vehicle 100 in a left direction. On the other hand, as shown in FIG. 2C, in a case where the host vehicle 100 deviates from the center of the host vehicle lane LN1 to the left side and the deviation amount dW is greater than zero, the vehicle control device 10 controls the operation of the steering device 23 to turn the host vehicle 100 in a right direction. With this, it is possible to make the host vehicle 100 travel at the center of the host vehicle lane LN1.

### Follow-Up Traveling Control

When the execution of the follow-up traveling control is requested by an operation of the driving assistance selection actuator 48, the vehicle control device 10 executes the follow-up traveling control. The follow-up traveling control is control for automatically accelerating and decelerating the host vehicle 100 by controlling the operation of the drive device 21 and the braking device 22 such that the host vehicle 100 travels to follow up a vehicle (preceding vehicle 200) that travels in front of the host vehicle 100.

In a case where the follow-up traveling control starts, the vehicle control device 10 acquires a distance (inter-vehicle distance D) between the host vehicle 100 and the preceding vehicle 200 (see FIG. 3A). The vehicle control device 10 acquires the inter-vehicle distance D based on the surrounding detection information IS.

The vehicle control device 10 acquires a difference (relative speed dV) between the vehicle speed (host vehicle speed V100) of the host vehicle 100 and a vehicle speed (preceding vehicle speed V200) of the preceding vehicle 200. The vehicle control device 10 acquires the relative speed dV based on the surrounding detection information IS.

Then, the vehicle control device 10 sets, as a target inter-vehicle distance Dtgt, an inter-vehicle distance D for which a time (predicted reaching time TTC) obtained through division by the relative speed dV at the moment is a predetermined time (predetermined predicted reaching time TTCref). That is, the vehicle control device 10 sets, as the target inter-vehicle distance Dtgt, the inter-vehicle distance D for which a relationship of the relative speed dV at the moment, the predetermined predicted reaching time TTCref, and the inter-vehicle distance D is a relationship of Expression 1 described below. TTCref = D/dV ... (1)

The follow-up traveling control is control for making the host vehicle 100 travel to follow up the preceding vehicle 200 by controlling the operation of the drive device 21 and the braking device 22 such that the inter-vehicle distance D coincides with the target inter-vehicle distance Dtgt.

As shown in FIG. 3B, in a case where the inter-vehicle distance D is longer than the target inter-vehicle distance Dtgt, the vehicle control device 10 controls the operation of the drive device 21 to accelerate the host vehicle 100. On the other hand, as shown in FIG. 3C, in a case where the inter-vehicle distance D is shorter than the target inter-vehicle distance Dtgt, the vehicle control device 10 controls the operation of at least one of the drive device 21 and the braking device 22 to decelerate the host vehicle 100. With this, it is possible to make the host vehicle 100 travel to follow up the preceding vehicle 200.

When there is no preceding vehicle 200, the vehicle control device 10 executes constant-speed traveling control. The constant-speed traveling control is control for automatically accelerating and decelerating the host vehicle 100 by controlling the operation of at least one of the drive device 21 and the braking device 22 such that the host vehicle speed V100 coincides with the predetermined vehicle speed Vset. The predetermined vehicle speed Vset is a vehicle speed that is set by an operation of the driver DR on the driving assistance selection actuator 48.

### Abnormality Countermeasure Control

When the driver DR is in the abnormal state while the lane keeping control and the follow-up traveling control are being executed, the vehicle control device 10 executes the abnormality countermeasure control (so-called dead-man control).

The abnormality countermeasure control includes abnormality notification control, abnormality countermeasure traveling control, and abnormality alarm control.

The abnormality notification control is control for alerting the driver DR or informing an occupant of the host vehicle 100 that the host vehicle 100 is to be automatically stopped or that the host vehicle 100 is stopped since an abnormality occurs in the driver DR.

The abnormality countermeasure traveling control is control for decelerating and stopping the host vehicle 100. More specifically, the abnormality countermeasure traveling control is control for controlling the operation of the drive device 21 and the braking device 22 to automatically decelerate and stop the host vehicle 100 such that the host vehicle 100 is to be safely stopped.

The abnormality alarm control is control for informing the outside of the host vehicle 100 that the driver DR falls into the abnormal state. In particular, in this example, the abnormality alarm control is control for informing a person outside the host vehicle 100 that the host vehicle 100 is to be stopped or the host vehicle 100 is stopped since the driver DR falls into the abnormal state.

The vehicle control device 10 monitors the status of the driver DR based on the driver information ID during traveling of the host vehicle 100 and continuously determines whether or not an abnormality condition CD that the driver DR is in the abnormal state is established.

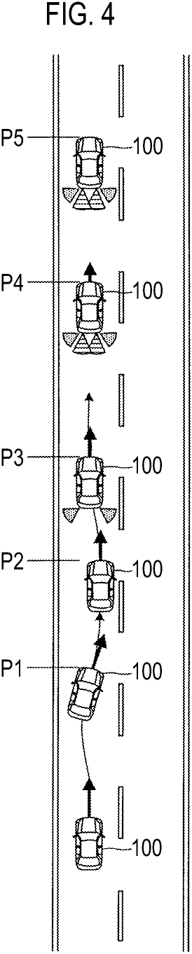

For example, in a case where determination is made that the abnormality condition CD is established when the host vehicle 100 travels at a point indicated by reference numeral P1 in FIG. 4, the vehicle control device 10 determines whether or not a time (first duration T1) for which determination continues to be made that the abnormality condition CD is established reaches a predetermined time (first determination time T1th).

For example, in a case where the first duration T1 reaches the first determination time T1th when the host vehicle 100 travels to a point indicated by reference numeral P2 in FIG. 4, the vehicle control device 10 starts the abnormality notification control while continuing the lane keeping control and the follow-up traveling control.

In this case, the vehicle control device 10 starts steering wheel holding request display processing and first warning sound output processing as processing of the abnormality notification control. The steering wheel holding request display processing is processing for displaying an image for requesting the driver DR to grip the steering wheel on the display device 72. The first warning sound output processing is processing of discontinuously outputting sound of a predetermined volume (first volume V1) from the acoustic device 71 at a predetermined time interval (first time interval Tiv1).

Thereafter, the vehicle control device 10 determines whether or not a time (second duration T2) for which determination continues to be made that the abnormality condition CD is established reaches a predetermined time (second determination time T2th) after the first duration T1 reaches the first determination time T1th.

For example, in a case where the second duration T2 reaches the second determination time T2th when the host vehicle 100 travels to a point indicated by reference numeral P3 in FIG. 4, the vehicle control device 10 starts the abnormality countermeasure traveling control and the abnormality alarm control while continuing the lane keeping control, the follow-up traveling control, and the abnormality notification control.

In this case, the vehicle control device 10 starts slow deceleration processing as processing of the abnormality countermeasure traveling control. The slow deceleration processing is processing of decelerating the host vehicle 100 at a comparatively small deceleration (first deceleration GD1) by controlling the operation of the drive device 21 or the braking device 22. Note that the vehicle control device 10 compares the deceleration (first deceleration GD1) in the slow deceleration processing with a deceleration (follow-up deceleration) in the follow-up traveling control, when the first deceleration GD1 is greater than the follow-up deceleration, decelerates the host vehicle 100 at the first deceleration GD1, and when the follow-up deceleration is greater than the first deceleration GD1, decelerates the host vehicle 100 at the follow-up deceleration.

In this case, the vehicle control device 10 starts the steering wheel holding request display processing, automatic vehicle stop notice display processing, and second warning sound output processing as processing of the abnormality notification control. The steering wheel holding request display processing is processing of displaying the image for requesting the driver DR to grip the steering wheel on the display device 72 as described above. The automatic vehicle stop notice display processing is processing of displaying an image for noticing, to the occupant of the host vehicle 100, that the host vehicle 100 is to be automatically stopped, on the display device 72. The second warning sound output processing is processing of discontinuously outputting sound of a predetermined volume (second volume V2) from the acoustic device 71 at a predetermined time interval (second time interval Tiv2). The second volume V2 is set to a volume greater than the first volume V1, and the second time interval Tiv2 is set to an interval shorter than the first time interval Tiv1.

In this case, the vehicle control device 10 starts hazard blinking processing as processing of the abnormality alarm control. The hazard blinking processing is processing of causing the hazard blinking of the blinkers 31.

Thereafter, the vehicle control device 10 determines whether or not a time (third duration T3) for which determination continues to be made that the abnormality condition CD is established after the second duration T2 reaches the second determination time T2th reaches a predetermined time (third determination time T3th).

For example, in a case where the third duration T3 reaches the third determination time T3th when the host vehicle 100 travels to a point indicated by reference symbol P4 in FIG. 4, the vehicle control device 10 switches processing as the abnormality countermeasure traveling control from the slow deceleration processing to vehicle stop deceleration processing while continuing the lane keeping control, the abnormality notification control, and the abnormality alarm control. The vehicle stop deceleration processing is processing of decelerating the host vehicle 100 at a comparatively large deceleration (second deceleration GD2) to stop the host vehicle 100 by controlling the operation of the braking device 22. The second deceleration GD2 is set to a value greater than the first deceleration GD1.

In this case, the vehicle control device 10 switches the processing of the abnormality notification control from the steering wheel holding request display processing, the automatic vehicle stop notice display processing, and the second warning sound output processing to automatic vehicle stop execution display processing and third warning sound output processing. The automatic vehicle stop execution display processing is processing of displaying, on the display device 72, an image for informing the occupant of the host vehicle 100 that control for automatically stopping the host vehicle 100 is being executed. The third warning sound output processing is processing of discontinuously outputting sound of a predetermined volume (third volume V3) from the acoustic device 71 at a predetermined time interval (third time interval Tiv3). The third volume V3 is set to a volume greater than the second volume V2, and the third time interval Tiv3 is set to an interval shorter than the second time interval Tiv2.

In this case, the vehicle control device 10 starts, as the processing of the abnormality alarm control, starts horn sounding processing and stop lamp turn-on processing while continuing the hazard blinking processing. The horn sounding processing is processing of outputting sound from the horn 81. The stop lamp turn-on processing is processing of turning on the stop lamps 32.

Thereafter, for example, in a case where the host vehicle 100 is stopped at a point indicated by reference numeral P5 in FIG. 4, the vehicle control device 10 stops the lane keeping control while continuing the abnormality notification control and the abnormality alarm control, and switches the processing as the abnormality countermeasure traveling control from the vehicle stop deceleration processing to vehicle stop holding processing. The vehicle stop holding processing is processing of maintaining the host vehicle 100 in the stop state by controlling the operation of the braking device 22 and the vehicle stop holding device 30.

In this case, the vehicle control device 10 switches the processing of the abnormality notification control from the automatic vehicle stop execution display processing and the third warning sound output processing to automatic vehicle stop completion display processing and fourth warning sound output processing. The automatic vehicle stop completion processing is processing of displaying, on the display device 72, an image for informing the occupant of the host vehicle 100 that the stop of the host vehicle 100 is completed. The fourth warning sound output processing is processing of discontinuously outputting sound of a predetermined volume (fourth volume V4) from the acoustic device 71 at a predetermined time interval (fourth time interval Tiv4). The fourth volume V4 is set to a volume greater than the third volume V3, and the fourth time interval Tiv4 is set to an interval shorter than the third time interval Tiv3.

In this case, the vehicle control device 10 continues the hazard blinking processing, the horn sounding processing, and the stop lamp turn-on processing as the processing of the abnormality alarm control.

### Stop of Driving Assistance Control

Incidentally, when a predetermined condition is established, it is preferable that stop the driving assistance control depending on the established condition. From this, when the predetermined condition is established, the vehicle control device 10 stops the driving assistance control depending on the established condition.

Specifically, when any one of a first lane keeping stop condition CLs1 to a fourth lane keeping stop condition CLs4 is established during the execution of the lane keeping control, the vehicle control device 10 stops the lane keeping control. The first lane keeping stop condition CLs1 is a condition that the stop of the lane keeping control is requested by an operation on the driving assistance selection actuator 48. The second lane keeping stop condition CLs2 is a condition that the driver input steering torque TQdriver is equal to or greater than predetermined steering torque TQdriver _th. The third lane keeping stop condition CLs3 is a condition that the vehicle stop holding request actuator 49 is operated and the abnormality countermeasure control is not being executed. The fourth lane keeping stop condition CLs4 is a condition that the shift lever 451 is operated to set the parking range and the abnormality countermeasure control is not being executed.

When any one of a first follow-up traveling stop condition CAs I to a fifth follow-up traveling stop condition CAs5 is established during the execution of the follow-up traveling control, the vehicle control device 10 stops the follow-up traveling control. The first follow-up traveling stop condition CAs 1 is a condition that the stop of the follow-up traveling control is requested by an operation on the driving assistance selection actuator 48. The second follow-up traveling stop condition CAs2 is a condition that the accelerator pedal operation amount AP is equal to or greater than a predetermined accelerator pedal operation amount threshold value APth. The third follow-up traveling stop condition CAs3 is a condition that the brake pedal operation amount BP is equal to or greater than a predetermined brake pedal operation amount threshold value BPth. The fourth follow-up traveling stop condition CAs4 is a condition that the vehicle stop holding request actuator 49 is operated and the abnormality countermeasure control is not being executed. The fifth follow-up traveling stop condition CAs5 is a condition that the shift lever 451 is operated to set the parking range and the abnormality countermeasure control is not being executed.

When any one of a first abnormality countermeasure stop condition CDs1 to a fifth abnormality countermeasure stop condition CDs5 is established during the execution of the abnormality countermeasure control, the vehicle control device 10 determines that the driver DR is not in the abnormal state (that is, the driver DR is in the normal state) and stops the abnormality countermeasure control.

The first abnormality countermeasure stop condition CDs1 is a condition that an operation on the steering wheel is performed. The vehicle control device 10 determines that an operation on the steering wheel is performed when the driver input steering torque TQdriver equal to or greater than the predetermined steering torque threshold value TQth is detected.

The second abnormality countermeasure stop condition CDs2 is a condition that an operation on the accelerator pedal is performed. The vehicle control device 10 determines that an operation on the accelerator pedal is performed when the accelerator pedal operation amount AP equal to or greater than the predetermined accelerator pedal operation amount threshold value APth is detected.

The third abnormality countermeasure stop condition CDs3 is a condition that an operation on the brake pedal is performed. The vehicle control device 10 determines that an operation on the brake pedal is performed when the brake pedal operation amount BP equal to or greater than the predetermined brake pedal operation amount threshold value BPth is detected.

The fourth abnormality countermeasure stop condition CDs4 is a condition that an operation on the driving assistance selection actuator 48 is performed.

The fifth abnormality countermeasure stop condition CDs5 is a condition that determination can be made that the driver DR is not in the abnormal state. The vehicle control device 10 determines whether or not the driver DR is in the abnormal state based on the driver information ID after the start of the abnormality countermeasure control.

When the abnormality countermeasure control is being executed, and when the vehicle stop holding request actuator 49 or the shift lever 451 is operated, the vehicle control device 10 does not stop the abnormality countermeasure control. Of course, as described above, the vehicle control device 10 does not also stop the lane keeping control and the follow-up traveling control.

### Effects

A case where, when an operation on the vehicle stop holding request actuator 49 or the shift lever 451 is detected, determination is made that the driver DR is in the normal state, and the abnormality countermeasure control is stopped is also considered. Note that an occupant (for example, an occupant on an assistant driver's seat) other than the driver DR can comparatively readily operate the vehicle stop holding request actuator 49 or the shift lever 451, and in a case where the fact that the driver DR is in the abnormal state is known through the abnormality countermeasure control, the occupant is likely to operate the vehicle stop holding request actuator 49 or the shift lever 451 to stop the host vehicle 100. For this reason, it is not preferable to stop the abnormality countermeasure control when the vehicle stop holding request actuator 49 or the shift lever 451 is operated.

With the vehicle control device 10, even though an operation on the vehicle stop holding request actuator 49 or the shift lever 451 is detected, the abnormality countermeasure control is not stopped or the lane keeping control and the follow-up traveling control are not also stopped. Accordingly, it is possible to restrain the abnormality countermeasure control from being stopped in a situation in which the stop of the abnormality countermeasure control is not appropriate.

### Specific Operation

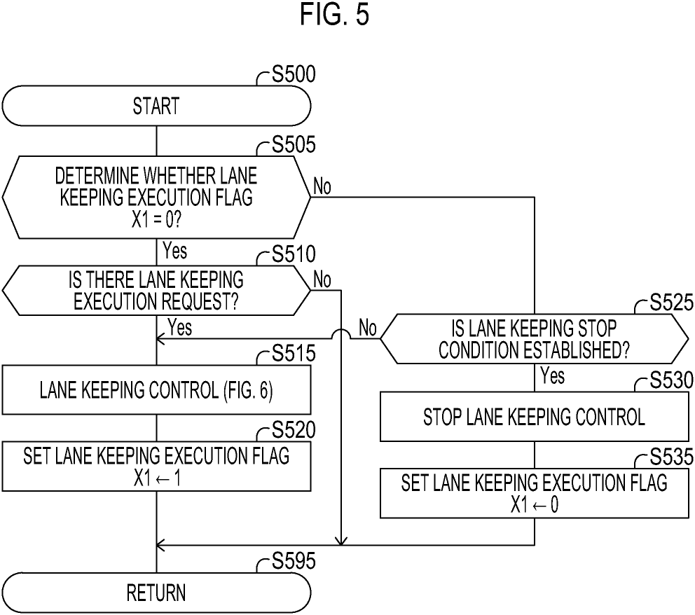

Next, a specific operation of the vehicle control device 10 will be described. The CPU of the ECU 90 of the vehicle control device 10 executes a routine shown in FIG. 5 in a predetermined calculation period.

Accordingly, in a case where a predetermined timing is reached, the CPU starts a process from Step S500 of FIG. 5, progresses the process to Step S505, and determines whether or not a value of a lane keeping execution flag X1 is "0". The lane keeping execution flag X1 is a flag representing whether or not the lane keeping control is under execution, and the value thereof is set to “1” when the lane keeping control is under execution and is set to “0” when the lane keeping control is not under execution.

When determination is “Yes” in Step S505, the CPU progresses the process to Step S510, and determines whether or not the execution of the lane keeping control is requested.

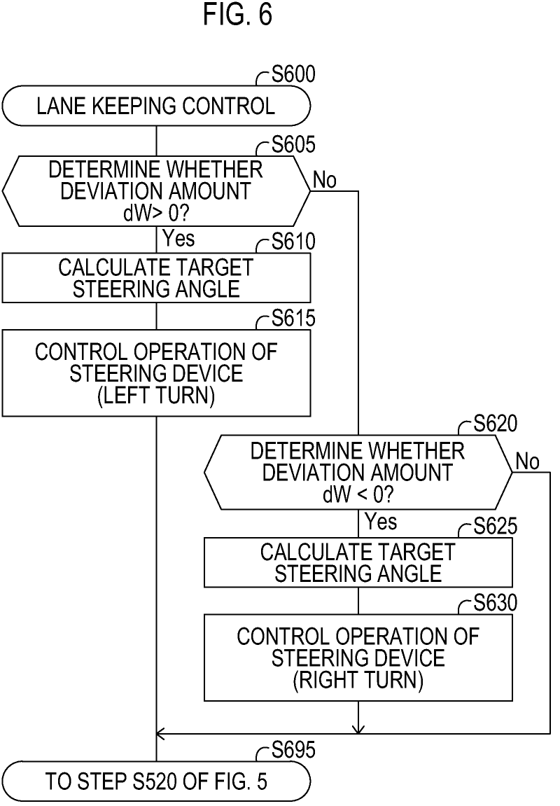

When determination is “Yes” in Step S510, the CPU progresses the process to Step S515, and executes a routine shown in FIG. 6. Accordingly, in a case where a process progresses to Step S515, the CPU starts the process from Step S600 of FIG. 6, progresses the process to Step S605, and determines whether or not the deviation amount dW is greater than zero. In this example, when the host vehicle center line VC deviates from the lane center line CL to the right side, the deviation amount dW is greater than zero.

When determination is “Yes” in Step S605, the CPU progresses the process to Step S610, and acquires, as a target steering angle θtgt, a steering angle θ for turning the host vehicle 100 to the left to make the deviation amount dW zero by calculation. Next, the CPU progresses the process to Step S615, and controls the operation of the steering device 23 such that the target steering angle θtgt acquired in Step S610 is realized. With this, the host vehicle 100 is steered to turn to the left side.

Next, the CPU progresses the process to Step S520 of FIG. 5 by way of Step S695, and sets the value of the lane keeping execution flag X1 to “1”. Next, the CPU progresses the process to Step S595, and ends the routine once.

On the other hand, when determination is “No” in Step S605 of FIG. 6, the CPU progresses the process to Step S620, and determines whether or not the deviation amount dW is smaller than zero. In this example, when the host vehicle center line VC deviates from the lane center line CL to the left side, the deviation amount dW is smaller than zero.

When determination is “Yes” in Step S620, the CPU progresses the process to Step S625, and acquires, as a target steering angle θtgt, a steering angle θ for turning the host vehicle 100 to the right side to make the deviation amount dW zero by calculation. Next, the CPU progresses the process to Step S630, and controls the operation of the steering device 23 such that the target steering angle θtgt acquired in Step S625 is realized. With this, the host vehicle 100 is steered to turn to the right side.

Next, the CPU progresses the process to Step S520 of FIG. 5 by way of Step S695, and sets the value of the lane keeping execution flag X1 to “1”. Next, the CPU progresses the process to Step S595, and ends the routine once.

On the other hand, when determination is “No” in Step S620 of FIG. 6, the CPU progresses the process directly to Step S520 of FIG. 5 by way of Step S695, and sets the value of the lane keeping execution flag X1 to “1”. Next, the CPU progresses the process to Step S595, and ends the routine once.

When determination is “No” in Step S510 of FIG. 5, the CPU progresses the process directly to Step S595, and ends the routine once.

When determination is “No” in Step S505, the CPU progresses the process to Step S525, and determines whether or not any one of the first lane keeping stop condition CLs1 to the fourth lane keeping stop condition CLs4 is established.

When determination is “Yes” in Step S525, the CPU progresses the process to Step S530, and stops the lane keeping control. Next, the CPU progresses the process to Step S535, and sets the value of the lane keeping execution flag X1 to "0". Next, the CPU progresses the process to Step S595, and ends the routine once.

On the other hand, when determination is “No” in Step S525, the CPU progresses the process to Step S515, and executes the routine shown in FIG. 6 as described above. Next, the CPU progresses the process to Step S520, and sets the value of the lane keeping execution flag X1 to “1”. Next, the CPU progresses the process to Step S595, and ends the routine once.

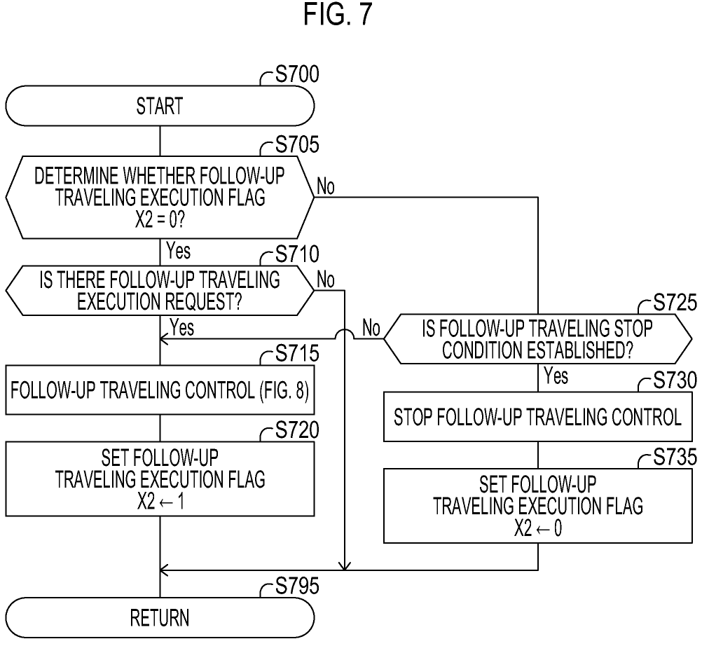

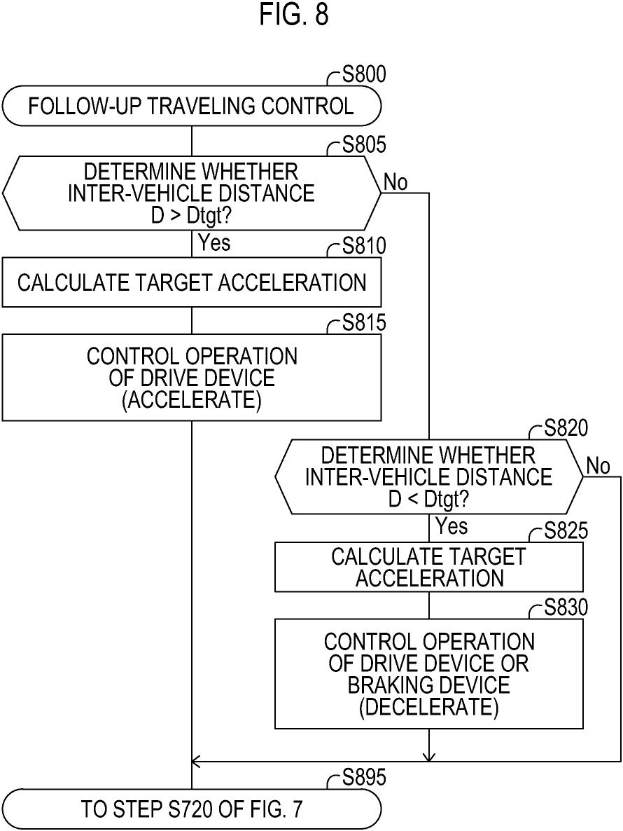

The CPU executes a routine shown in FIG. 7 in a predetermined calculation period.

Accordingly, in a case where a predetermined timing is reached, the CPU starts a process from Step S700 of FIG. 7, progresses the process to Step S705, and determines whether or not a value of a follow-up traveling execution flag X2 is “0”. The follow-up traveling execution flag X2 is a flag representing whether or not the follow-up traveling control is under execution, and the value thereof is set to “1” when the follow-up traveling control is under execution, and is set to “0” when the follow-up traveling control is not under execution.

When determination is “Yes” in Step S705, the CPU progresses the process to Step S710, and determines whether or not the execution of the follow-up traveling control is requested.

When determination is “Yes” in Step S710, the CPU progresses the process to Step S715, and executes a routine shown in FIG. 8. Accordingly, in a case where a process progresses to Step S715, the CPU starts a process from Step S800 of FIG. 8, progresses the process to Step S805, and determines whether or not the inter-vehicle distance D is greater than the target inter-vehicle distance Dtgt.

When determination is “Yes” in Step S805, the CPU progresses the process to Step S810, and acquires, as a target acceleration GAtgt, an acceleration GA of the host vehicle 100 for increasing the host vehicle speed V100 to make the inter-vehicle distance D coincide with the target inter-vehicle distance Dtgt by calculation. Next, the CPU progresses the process to Step S815, and controls the operation of the drive device 21 such that the target acceleration GAtgt acquired in Step S810 is realized. With this, the host vehicle 100 is accelerated.

Next, the CPU progresses the process to Step S720 of FIG. 7 by way of Step S895, and sets the value of the follow-up traveling execution flag X2 to “1”. Next, the CPU progresses the process to Step S795, and ends the routine once.

On the other hand, when determination is “No” in Step S805 of FIG. 8, the CPU progresses the process to Step S820, and determines whether or not the inter-vehicle distance D is smaller than the target inter-vehicle distance Dtgt.

When determination is “Yes” in Step S820, the CPU progresses the process to Step S825, and acquires, as a target deceleration GDtgt, a deceleration GD of the host vehicle 100 for decreasing the acceleration host vehicle speed V100 to make the inter-vehicle distance D coincide with the target inter-vehicle distance Dtgt by calculation. Next, the CPU progresses the process to Step S830, and controls the operation of the drive device 21 or the braking device 22 such that the target deceleration GDtgt acquired in Step S825 is realized. With this, the host vehicle 100 is decelerated.

Next, the CPU progresses the process to Step S720 of FIG. 7 by way of Step S895, and sets the value of the follow-up traveling execution flag X2 to “1”. Next, the CPU progresses the process to Step S795, and ends the routine once.

On the other hand, when determination is “No” in Step S820 of FIG. 8, the CPU progresses the process directly to Step S720 of FIG. 7 by way of Step S895, and sets the value of the follow-up traveling execution flag X2 to “1”. Next, the CPU progresses the process to Step S795, and ends the routine once.

When determination is “No” in Step S710 of FIG. 7, the CPU progresses the process directly to Step S795, and ends the routine once.

When determination is “No” in Step S705, the CPU progresses the process to Step S725, and determines whether or not any one of the first follow-up traveling stop condition CAs1 to the fifth follow-up traveling stop condition CAs5 is established.

When determination is “Yes” in Step S725, the CPU progresses the process to Step S730, and stops the follow-up traveling control. Next, the CPU progresses the process to Step S735, and sets the value of the follow-up traveling execution flag X2 to “0”. Next, the CPU progresses the process to Step S795, and ends the routine once.

On the other hand, when determination is “No” in Step S725, the CPU progresses the process to Step S715, and executes the routine shown in FIG. 8 as described above. Next, the CPU progresses the process to Step S720, and sets the value of the follow-up traveling execution flag X2 to “1”. Next, the CPU progresses the process to Step S795, and ends the routine once.

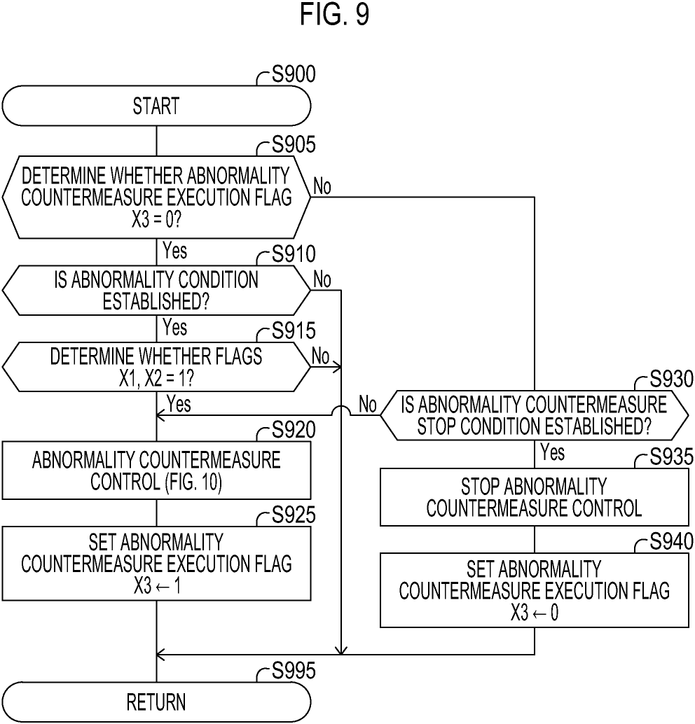

The CPU executes a routine shown in FIG. 9 in a predetermined calculation period.

Accordingly, in a case where a timing of processing is reached, the CPU starts a process from Step S900 of FIG. 9, progresses the process to Step S905, and determines whether or not a value of an abnormality countermeasure execution flag X3 is “0”. The abnormality countermeasure execution flag X3 is a flag representing whether or not the abnormality countermeasure control is under execution, and the value thereof is set to “1” when the abnormality countermeasure control is under execution, and is set to “0” when the abnormality countermeasure control is not under execution.

When determination is “Yes” in Step S905, the CPU progresses the process to Step S910, and determines whether or not the abnormality condition CD is established.

When determination is “Yes” in Step S910, the CPU progresses the process to Step S915, and determines whether or not the values of the lane keeping execution flag X1 and the follow-up traveling execution flag X2 are set to “1”.

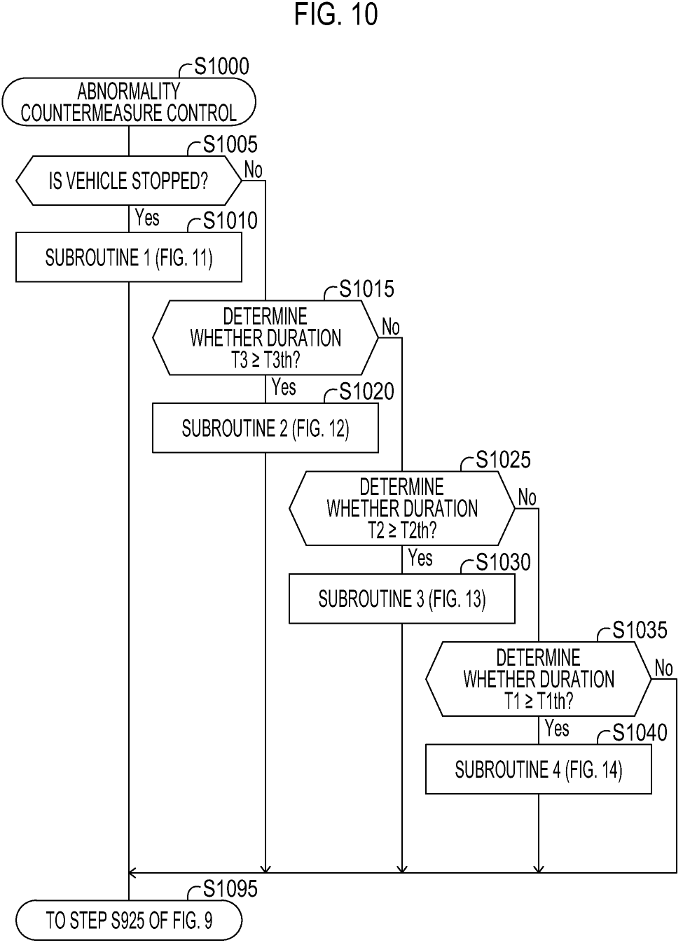

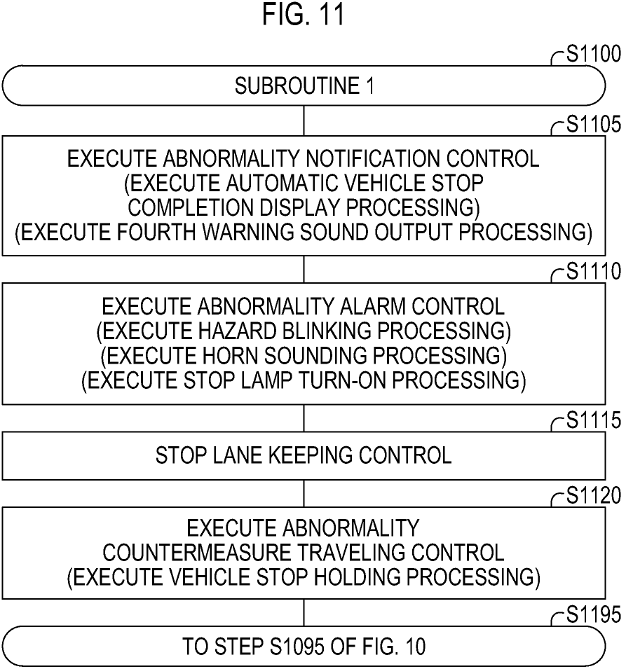

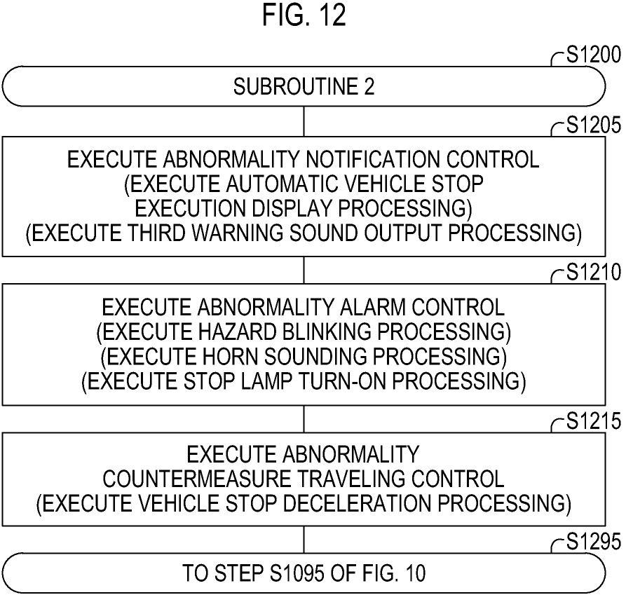

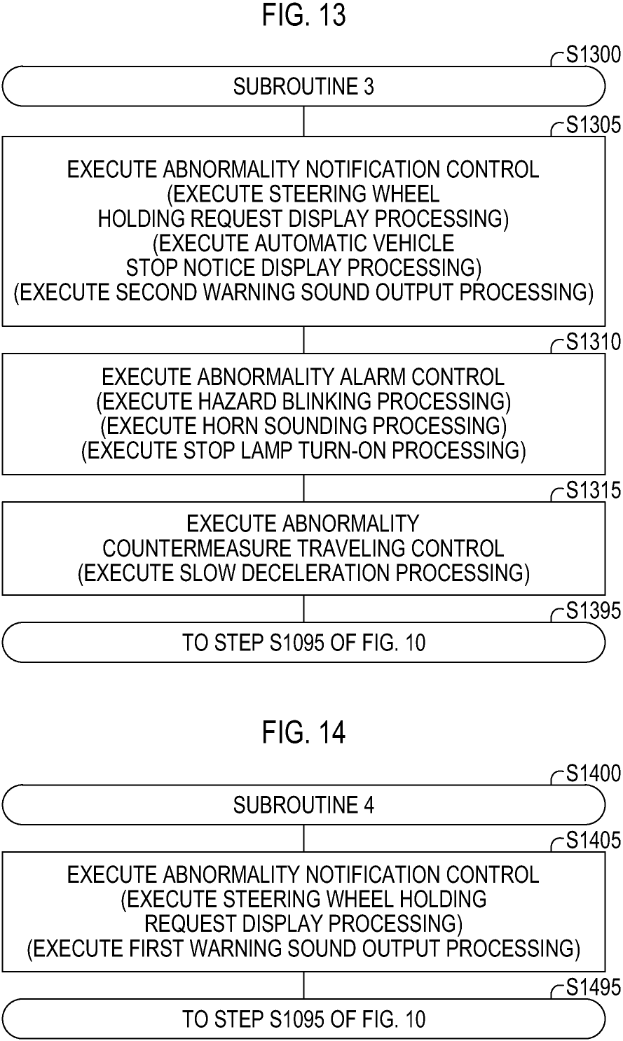

When determination is “Yes” in Step S915, the CPU progresses the process to Step S920, and executes a routine shown in FIG. 10. Accordingly, in a case where a process progresses to Step S920, the CPU starts the process from Step S1000 of FIG. 10, progresses the process to Step S1005, and determines whether or not the host vehicle 100 is stopped.

When determination is “Yes” in Step S1005, the CPU progresses the process to Step S1010, and executes a routine shown in FIG. 11. Accordingly, in a case where a process progresses to Step S1010, the CPU starts the process from Step S1100 of FIG. 11, progresses the process to Step S1105, and executes the abnormality notification control. Specifically, the CPU executes the automatic vehicle stop completion display processing and the fourth warning sound output processing as the processing of the abnormality notification control. Next, the CPU progresses the process to Step S1110, and executes the abnormality alarm control. Specifically, the CPU executes the hazard blinking processing, the horn sounding processing, and the stop lamp turn-on processing as the processing of the abnormality alarm control.

Next, the CPU progresses the process to Step S1115, and stops the lane keeping control. Next, the CPU progresses the process to Step S1120, and executes the abnormality countermeasure traveling control. Specifically, the CPU executes the vehicle stop holding processing as the processing of the abnormality countermeasure traveling control.

Next, the CPU progresses the process to Step S925 of FIG. 9 by way of Step S1195 and Step S1095 of FIG. 10, and sets the value of the abnormality countermeasure execution flag X3 to “1”. Next, the CPU progresses the process to Step S995, and ends the routine once.

On the other hand, when determination is “No” in Step S1005 of FIG. 10, the CPU progresses the process to Step S1015, and determines whether or not the third duration T3 is equal to or greater than the third determination time T3th.

When determination is “Yes” in Step S1015, the CPU progresses the process to Step S1020, and executes a routine shown in FIG. 12. Accordingly, in a case where a process progresses to Step S1020, the CPU starts the process from Step S1200 of FIG. 12, progresses the process to Step S1205, and executes the abnormality notification control. Specifically, the CPU executes the automatic vehicle stop execution display processing and the third warning sound output processing as the processing of the abnormality notification control. Next, the CPU progresses the process to Step S1210, and executes the abnormality alarm control. Specifically, the CPU executes the hazard blinking processing, the horn sounding processing, and the stop lamp turn-on processing as the processing of the abnormality alarm control.

Next, the CPU progresses the process to Step S1215, and executes the abnormality countermeasure traveling control. Specifically, the CPU executes the vehicle stop deceleration processing as the processing of the abnormality countermeasure traveling control.

Next, the CPU progresses the process to Step S925 of FIG. 9 by way of Step S1295 and Step S1095 of FIG. 10, and sets the value of the abnormality countermeasure execution flag X3 to “1”. Next, the CPU progresses the process to Step S995, and ends the routine once.

On the other hand, when determination is “No” in Step S1015, the CPU progresses the process to Step S 1025, and determines whether or not the second duration T2 is equal to or greater than the second determination time T2th.

When determination is “Yes” in Step S1025, the CPU progresses the process to Step S1030, and executes a routine shown in FIG. 13. Accordingly, in a case where a process progresses to Step S1030, the CPU starts the process from Step S1300 of FIG. 13, progresses the process to Step S1305, and executes the abnormality notification control. Specifically, the CPU executes the steering wheel holding request display processing, the automatic vehicle stop notice display processing, and the second warning sound output processing as the processing of the abnormality notification control. Next, the CPU progresses the process to Step S1310, and executes the abnormality alarm control. Specifically, the CPU executes the hazard blinking processing, the horn sounding processing, and the stop lamp turn-on processing as the processing of the abnormality alarm control.

Next, the CPU progresses the process to Step S1315, and executes the abnormality countermeasure traveling control. Specifically, the CPU executes the slow deceleration processing as the processing of the abnormality countermeasure traveling control.

Next, the CPU progresses the process to Step S925 of FIG. 9 by way of Step S1395 and Step S1095 of FIG. 10, and sets the value of the abnormality countermeasure execution flag X3 to “1”. Next, the CPU progresses the process to Step S995, and ends the routine once.

On the other hand, when determination is “No” in Step S1025, the CPU progresses the process to Step S1035, and determines whether or not the first duration T1 is equal to or greater than the first determination time T1th.

When determination is “Yes” in Step S1035, the CPU progresses the process to Step S1040, and executes a routine shown in FIG. 14. Accordingly, in a case where a process progresses to Step S1040, the CPU starts the process from Step S1400 of FIG. 14, progresses the process to Step S1405, and executes the abnormality notification control. Specifically, the CPU executes the steering wheel holding request display processing and the first warning sound output processing as the processing of the abnormality notification control.

Next, the CPU progresses the process to Step S925 of FIG. 9 by way of Step S1495 and Step S1095 of FIG. 10, and sets the value of the abnormality countermeasure execution flag X3 to “1”. Next, the CPU progresses the process to Step S995, and ends the routine once.

On the other hand, when determination is “No” in Step S1035 of FIG. 10, the CPU progresses the process directly to Step S925 of FIG. 9 by way of Step S1095 of FIG. 10, and sets the value of the abnormality countermeasure execution flag X3 to "1". Next, the CPU progresses the process to Step S995, and ends the routine once.

When determination is “No” in Step S910 or Step S915 of FIG. 9, the CPU progresses the process directly to Step S995, and ends the routine once.

When determination is “No” in Step S905 of FIG. 9, the CPU progresses the process to Step S930, and determines whether or not any one of the first abnormality countermeasure stop condition CDs1 to the fifth abnormality countermeasure stop condition CDs5 is established.

When determination is “Yes” in Step S930, the CPU progresses the process to Step S935, and stops the abnormality countermeasure control. Next, the CPU progresses the process to Step S940, and sets the value of the abnormality countermeasure execution flag X3 to “0”. Next, the CPU progresses the process to Step S995, and ends the routine once.

On the other hand, when determination is “No” in Step S930, the CPU progresses the process to Step S920 and executes the routine shown in FIG. 10 as described above. Next, the CPU progresses the process to Step S925, and sets the value of the abnormality countermeasure execution flag X3 to “1”. Next, the CPU progresses the process to Step S995, and ends the routine once.

The above is the specific operation of the vehicle control device 10.

The disclosure is not limited to the above-described embodiment, and various modification examples can be employed within the scope of the disclosure.

What is claimed is:

1. A vehicle control device that executes driving assistance control for assisting driving of a host vehicle by a driver and is configured to stop the driving assistance control under execution when a predetermined actuator of the host vehicle is operated,
wherein the vehicle control device is configured to:
execute, as the driving assistance control, abnormality countermeasure control for securing safe traveling of the host vehicle when the driver falls into an abnormal state having a problem in driving the host vehicle; and
when the predetermined actuator is operated, stop the driving assistance control when the abnormality countermeasure control is not being executed, and not stop the driving assistance control including the abnormality countermeasure control when the abnormality countermeasure control is being executed.

2. The vehicle control device according to claim 1, wherein the predetermined actuator is an actuator for operating a vehicle stop holding device that holds the host vehicle in a stop state.

3. The vehicle control device according to claim 1, wherein the abnormality countermeasure control includes abnormality countermeasure traveling control for decelerating and stopping the host vehicle.

4. The vehicle control device according to claim 1, wherein the abnormality countermeasure control includes abnormality alarm control for informing an outside of the host vehicle that the driver falls into the abnormal state.

5. The vehicle control device according to claim 1, wherein the driving assistance control includes follow-up traveling control for automatically performing acceleration and deceleration of the host vehicle such that the host vehicle travels to follow up a preceding vehicle.

6. The vehicle control device according to claim 1, wherein the driving assistance control includes lane keeping control for assisting a steering operation by the driver on the host vehicle such that the host vehicle travels within a lane.
